(19) United States
(12) Patent Application Publication
(10) Pub. No.: US 2013/0297650 A1
(43) Pub. Date: Nov. 7, 2013

(54) Using Multimedia Search to Identify Products

(71) Applicants: Wenlong Li, Beijing (CN); Xiaofeng Tong, Beijing (CN); Yimin Zhang, Beijing (CN)

(72) Inventors: Wenlong Li, Beijing (CN); Xiaofeng Tong, Beijing (CN); Yimin Zhang, Beijing (CN)

(21) Appl. No.: 13/994,768

(22) PCT Filed: Sep. 12, 2011
(86) PCT No.: PCT/CN2011/001547

§ 371 Date: Jun. 17, 2013

(51) Int. Cl. G06F 17/30

(52) U.S. Cl. CPC G06F 17/30023
USPC 707/769

(57) ABSTRACT

A product in television program currently being watched can be identified by extracting at least one decoded frame from a television transmission. The frame can be transmitted to a separate mobile device for requesting an image search and for receiving the search results. The search results can be used to identify the product.

### BACKGROUND

This relates generally to computers and, particularly, computerized image analysis. Television may be distributed by broadcasting television programs using radio frequency transmissions of analog or digital signals. In addition, television programs may be distributed over cable and satellite systems. Finally, television may be distributed over the Internet using streaming. As used herein, the term “television transmission” includes all of these modalities of television distribution. As used herein, “television” means the distribution of program content, either with or without commercials and includes both conventional television programs, as well as the distribution of video games.

Systems are known for determining what programs users are watching. For example, the IntoNow service records, on a cell phone, audio signals from television programs being watched, analyzes those signals, and uses that information to determine what programs viewers are watching. One problem with audio analysis is that it is subject to degradation from ambient noise. Of course, ambient noise in the viewing environment is common and, thus, audio based systems are subject to considerable limitations.

### BRIEF DESCRIPTION OF THE DRAWINGS

FIG. 1 is a high level architectural depiction of one embodiment of the present invention;

FIG. 2 is a block diagram of a set top box according to one embodiment of the present invention;

FIG. 3 is a flow chart for a mobile grabber in accordance with one embodiment of the present invention;

FIG. 4 is a flow chart for a multimedia grabber in accordance with one embodiment of the present invention;

FIG. 5 is a flow chart for a shopping application in accordance with one embodiment of the present invention; and

FIG. 6 is a flow chart for a sequence for maintaining a table according to one embodiment.

### DETAILED DESCRIPTION

In accordance with some embodiments, a multimedia segment, such as a limited duration electronic representation of a video frame or clip, metadata or audio, may be grabbed from the actively tuned television channel currently being watched by one or more viewers. This multimedia segment may then be transmitted to a mobile device in one embodiment. The mobile device may then transmit the information to a server for searching to identify a product depicted in the television program. For example, image searching may ultimately be used to determine what product is being depicted. Once the product is identified, then it is possible to provide the viewer with a variety of other shopping services. These services can include identifying other vendors of the product, price comparison, and retailer location services.

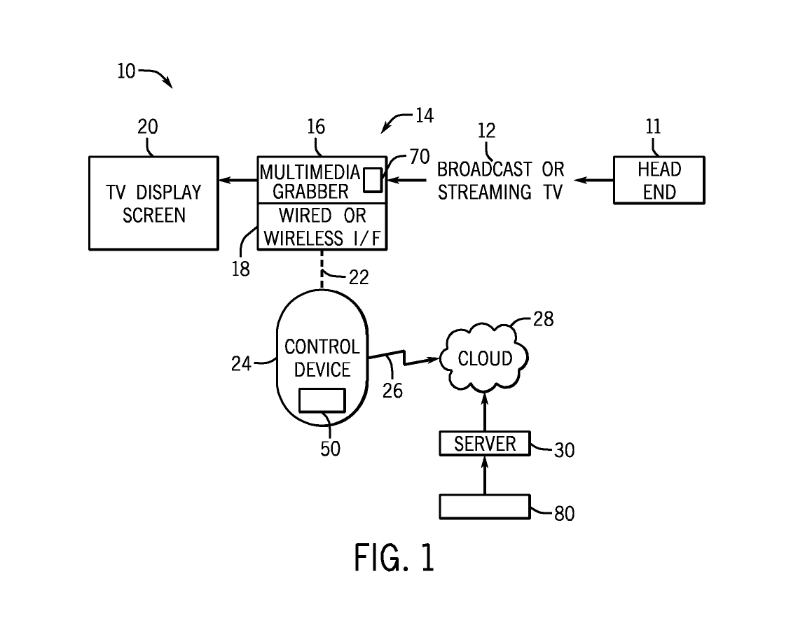

Referring to FIG. 1, a television screen 20 may be coupled to a processor-based device 14, in turn, coupled to a television transmission 12. This transmission may be distributed over the Internet or over the airwaves, including radio frequency broadcast of analog or digital signals, cable distribution, or satellite distribution. The processor-based system 14 may be a standalone device separate from the television receiver or may be integrated within the television receiver. It may, for example, include the components of a conventional set top box and may, in some embodiments, be responsible for decoding received television transmissions.

In one embodiment, the processor-based system 14 includes a multimedia grabber 16 that grabs an electronic representation of a video frame or clip (i.e. a series of frames), metadata or sound from the decoded television transmission currently tuned to by a receiver (that may be part of the device 14 in one embodiment). The processor-based system 14 may also include a wired or wireless interface 18 which allows the multimedia that has been grabbed to be transmitted to an external control device 24. This transmission 22 may be over a wired connection, such as a Universal Serial Bus (USB) connection, widely available in television receivers and set top boxes, or over any available wireless transmission medium, including those using radio frequency signals and those using light signals.

In other embodiments, undecoded content can be grabbed and then decoded in the control device 24 or elsewhere.

The control device 24 may be a mobile device, including a cellular telephone, a laptop computer, a tablet computer, a mobile Internet device, or a remote control for a television receiver, to mention a few examples. The device 24 may also be non-mobile, such as a desk top computer or entertainment system. The device 24 and the system 14 may be part of a wireless home network in one embodiment. Generally, the device 24 has its own separate display so that it can display information independently of the television display screen. In embodiments where the device 24 does not include its own display, a display may be overlaid on the television display, such as by a picture-in-picture display.

The control device 24, in one embodiment, may communicate with a cloud 28. In the case where the device 24 is a cellular telephone, for example, it may communicate with the cloud by cellular telephone signals 26, ultimately conveyed over the Internet. In other cases, the device 24 may communicate through hard wired connections, such as network connections, to the Internet. As still another example, the device 24 may communicate over the same transport medium that transported the television transmission. For example, in the case of a cable system, a device 24 may provide signals through the cable system to the cable head end or server 11. Of course, in some embodiments, this may consume some of the available transmission bandwidth. Thus, in some embodiments, the device 24 may not be a mobile device and may even be part of the processor-based system 14.

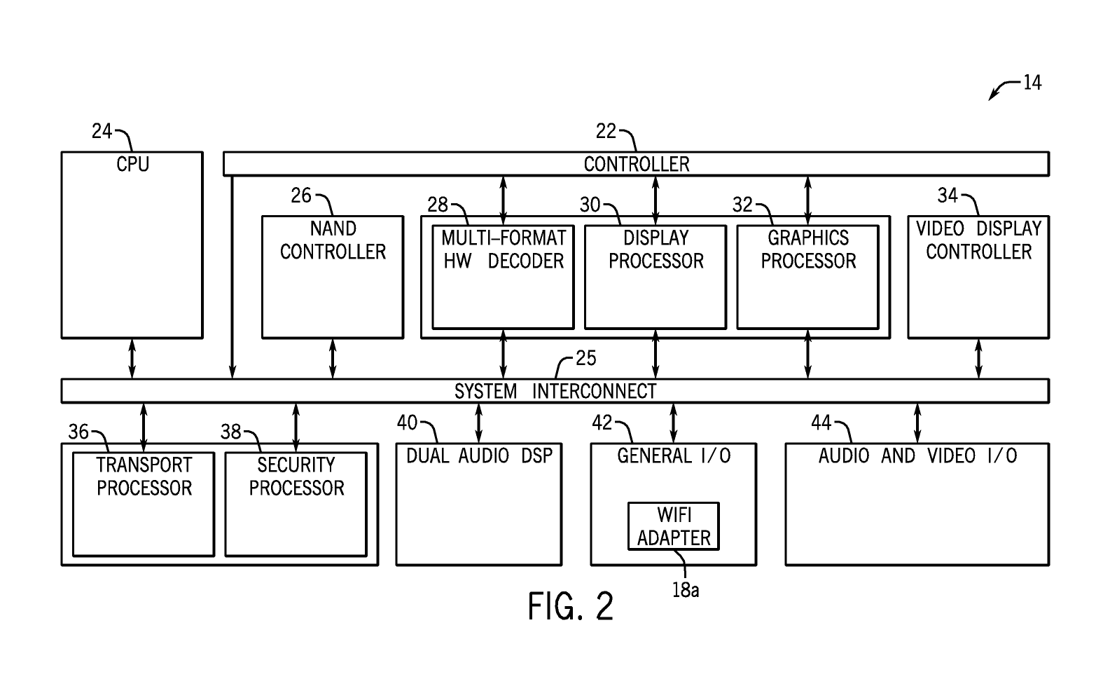

Referring to FIG. 2, one embodiment of the processor-based system 14 is depicted, but many other architectures may be used as well. The architecture depicted in FIG. 2 corresponds to the CE4100 platform, available from Intel Corporation. It includes a central processing unit 24, coupled to a system interconnect 25. The system interconnect is coupled to a NAND controller 26, a multi-format hardware decoder 28, a display processor 30, a graphics processor 32, and a video display controller 34. The decoder 28 and processors 30 and 32 may be coupled to a controller 22, in one embodiment.

The system interconnect may be coupled to transport processor 36, security processor 38, and a dual audio digital signal processor (DSP) 40. The digital signal processor 40 may be responsible for decoding the incoming video transmission. A general input/output (I/O) module 42 may, for example, be coupled to a wireless adaptor, such as a WiFi adaptor 18a. This adapter enables sending signals to a wireless control device 24, in some embodiments. Also coupled to the system interconnect 25 is an audio and video input/output device 44. This device 44 may provide decoded video output and may be used to output audio or video frames or an audio or video clip in some embodiments.

In some embodiments, the processor-based system 14 may be programmed to output multimedia segments upon the satisfaction of a particular criteria. One such criteria is a user selection, for example, by providing an input through input/output devices, such as a keyboard or a touch screen. Also, a video camera may record user gestures. Those gestures may be analyzed to identify a command to capture a multimedia segment. In such case, the video multimedia signal is output on command. Also, detection of an audible command from a viewer, for example using speech recognition, may be used to trigger multimedia segment capture. Another option is that the processor-based system 14 detects various activities in the incoming video transmission to trigger the multimedia grabbing. Examples of activities or events include detection of the start of a commercial.

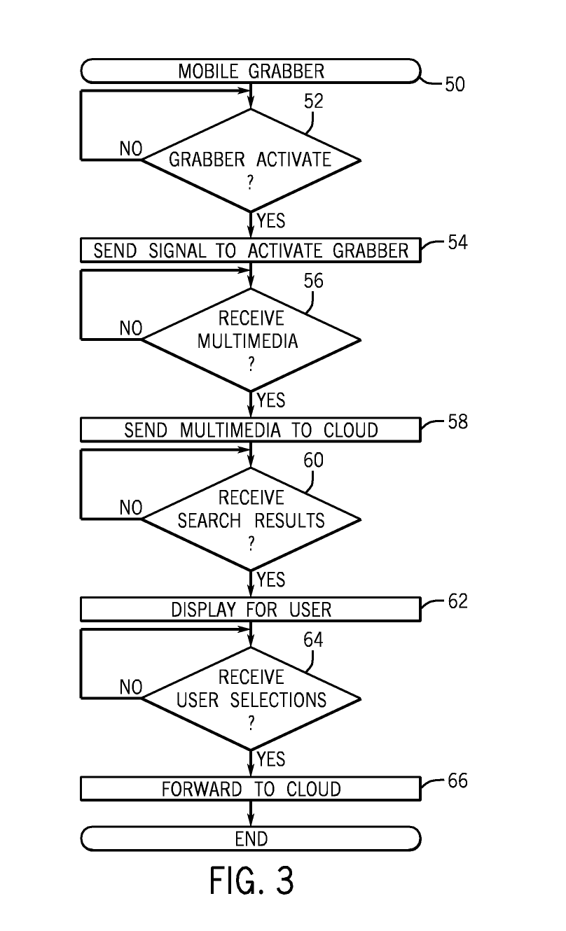

FIG. 3 shows a sequence for an embodiment of the control device 24. The sequence may be implemented in software, hardware, and/or firmware. In software or firmware based embodiments, the sequence may be implemented by computer executable instructions stored in a non-transitory computer readable medium, such as an optical, magnetic, or semiconductor storage device. For example, the software or firmware sequence may be stored in storage 50 on the control device 24.

While an embodiment is depicted in which the control device 24 is a mobile device, non-mobile embodiments are also contemplated. For example, the control device 24 may be integrated within the system 14.

Initially, a check at diamond 52 determines whether the grabber 16 has been activated, as indicated in diamond 52. In some embodiments, the grabber 16 is not always active so that the device 24 computing capacity is not wasted. For example, the user may activate an application on the user's cell phone to initiate the grabbing activity and, in such case, the grabber activation is detected at diamond 52.

Then, at block 54, a signal may be sent from the control device 24 to the processor-based system 14 to initiate the multimedia grabbing of electronic representations of a multimedia segment 16. When the control device 24 receives a multimedia segment, as detected at diamond 56, in some embodiments, the control device 24 may send the multimedia segment to the cloud 28 for analysis to identify the product being shown or described (block 58). Of course, it can send the multimedia segment over a network to any server in other embodiments. It can also send the multimedia segment to the head end 11 for image, text, or audio analysis, as another example.

If an electronic representation of audio is captured, the captured audio representation may be converted to text, for example, in the control device 24, the system 14 or the cloud 28. Then the text can be searched to identify the product.

Similarly, metadata may be analyzed to identify information to use in a text search to identify the product. In some embodiments, more than one of audio, metadata, video frames or clips, may be used as input for keyword Internet or database searches to identify a product. In addition, a user may push information to friends over social networks in hopes of receiving product information from them.

An analysis engine then performs a multimedia search to identify the depicted product. This search may be a simple Internet or database search or it may be a more focused search. For example, the transmission in block 58 may include the current time or video capture and location of the control device 24. This information may be used to focus the search using information about what products are being shown at particular times and in particular locations. For example, a database may be provided on a website that correlates television programs available in different locations at different times and this database may be image searched to find an image that matches a captured frame to identify the program. In addition, metadata or advertisement content providers could include location or contact information in association with the content they provide.

In some embodiments, the user can append annotations and identify the feature of interest in the captured segment. The annotations may be enabled by an application running on the control device 24 in one embodiment. The annotations may be used to focus the searching. As another option, eye gaze detection may be used to identify a product of interest within a video frame or clip.

The identification of the product may be done by using a visual search tool. The image frame or clip is matched to existing frames or clips within the search database. In some cases, a series of matches may be identified and, in such case, those matches may be sent back to the control device 24. When a check at diamond 60 determines that the search results have been received by the control device 24, the search results may be displayed for the user, as indicated at block 62. The control device 24 then receives the user selection of one of the search results that conforms to the information the user wanted, such as the product being viewed. Then, once the user selection has been received, as indicated in diamond 64, the selected search result may then be forwarded to the cloud, as indicated in block 66. This allows the television product identification to be used to provide other services for the viewer or for third parties, such as the provision of additional information about the product.

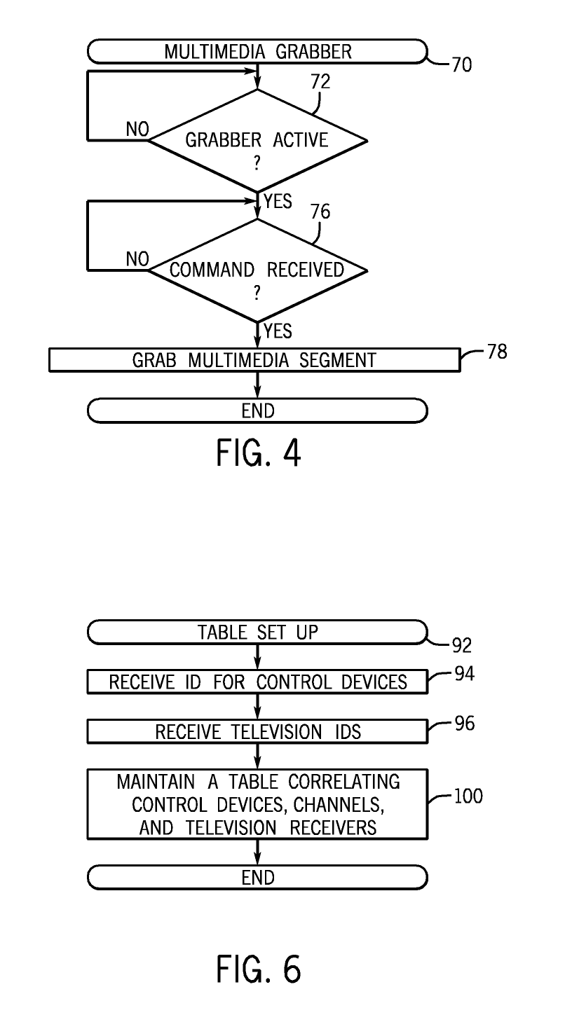

Next, referring to FIG. 4, a sequence may be implemented within the processor-based system 14. Again, the sequence may be implemented in firmware, hardware, or software. In software or firmware embodiments, it may be implemented by one or more non-transitory computer readable media. For example, the multimedia grabber sequence may be stored in a storage 70 on the multimedia grabber device 16.

Initially, a check at diamond 72 determines whether the grabber feature has been activated. In some embodiments, video content analysis may be used. For example, the user may request that the system screen for a particular product, such as a laptop computer or advertisements for a laptop computer, so the system may analyze the ongoing content using video content analysis to locate the desired product, and capture a multimedia segment where that product is being shown or described.

If a command is received, as determined in diamond 76, multimedia is grabbed and transmitted to the control device 24, as indicated in block 78.

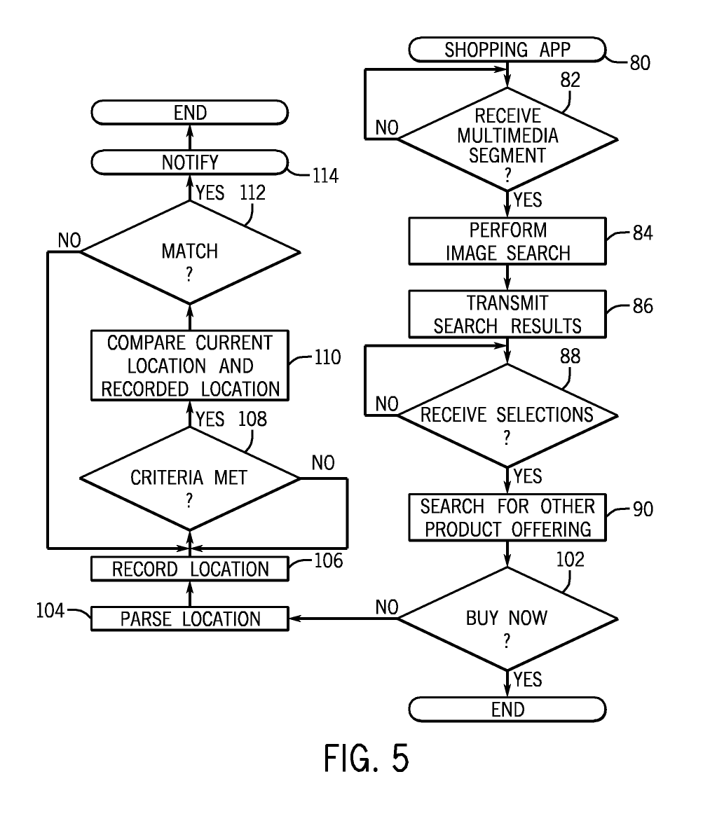

Referring to FIG. 5, a shopping application is indicated by a sequence. The sequence may be implemented in software, firmware, and/or hardware. In software and firmware based embodiments, it may be implemented by one or more non-transitory computer readable media. For example, the computer readable instructions can be stored in a storage 80, associated with a server 30, shown in FIG. 1.

While an embodiment using a cloud is illustrated, of course, the same sequence may be implemented by any server, coupled over any suitable network, by the control device 24 itself, by the processor-based device 14, or by the head end 11 in other embodiments. Initially, a check at diamond 82 determines whether the multimedia segment has been received. If so, a visual search is performed, in the case where the multimedia is an electronic representation of a video frame or clip, as indicated in block 84. In the case of an audio clip, the audio may be converted to text and searched. If the multimedia segment is metadata, the metadata may be parsed for searchable content. Then, in block 86, the search results are transmitted back to the control device 24, for example. The control device 24 may receive user input or selection about which of the search results is most relevant. The system waits for the selection from the user and, when the selection is received, as determined in diamond 88, a task may be performed based on the identified product, as indicated at block 90. For example, a search may be undertaken to identify other sources of the same product and vendor comparisons may be automatically implemented based, for example, on price, location, and availability.

One way such searching may be conducted may be to match the current image with images in the database or on an Internet and then to search for text associated with those Internet or database resident images. Then common terms between the different images may be analyzed to determine the name of the product. Thus, image searching may be used to determine the name of the product. Likewise, audio segments within the multimedia segment may be searched to see if the name of the product is actually referenced and so the audio may be converted to text and then searched for product information within the text.

In addition, the user can provide input information to provide a clue as to why the user selected a particular image. This may be done using text entry boxes, annotations to selected messages or separate communications as examples.

Then the user can be asked, at diamond 102, whether the user wishes to buy the product now. This may mean buying the product shown in the television show, for example, through a television shopping network option or through one of the vendors identified in the search.

If the user wishes to buy the product now, the system may assist with the purchasing process. For example, heuristics may be used to identify contact information from within the web or database information. This information may be used to initiate a purchase transaction by providing the user's credit card information and address information to fill out online forms. That information may then be conveyed to the vendor to automatically initiate the transaction. Alternatively, contact information may be identified within the database of the Internet webpages that are located in the search and that information may be provided to the user for the user's selection of the vendor.

If the user decides not to purchase now, the user can select a particular vendor that the user may wish to visit to view the product. Thus, if the user selects a webpage for a particular vendor, the location or contact information of that vendor may be automatically parsed from the webpage (block 104). This may be done by recognizing information that is in the format of address information which may include numbers, followed by text or may identify webpage information based on its particular format. Similarly, phone numbers and fax numbers can be identified in the same way. Once the location or contact information has been identified, the location is recorded, as indicated in block 106.

The user may specify, at this time or during setup, a proximity factor. For example, the user may wish to be identified when the user is within a given distance of the identified vendor. A check at diamond 108 determines whether that proximity criteria has been met. If so, the current location and the recorded location may be compared (block 110) and, if they match, as determined in diamond 112, the user may be notified at 114 that the user is within the specified distance of the indicated vendor. Thus, the system may constantly monitor the user's position using global positioning system sensors within the user's cell phone or other mobile device and simply lets the user know when the user is in proximity to that vendor.

This background location monitoring lessens the need for the user, in many cases, to immediately go to see the product. Instead, the user can just continue on the user's normal activities and the system will monitor his/her location. When the user is proximate to the identified vendor, then a notification can be provided.

A similar service can also be implemented in other ways. For example, the user may take a picture of a product in the store, may provide some identifying information, or the system may identify the product on its own, and use the same techniques to locate other vendors of the same product.

In addition, the location indicator service may be useful in cases where the product was not even identified through television programming or a photograph. For example, the user may simply see an advertisement mentioning a vendor or hear about a store, a restaurant, a museum, or any other location the user would like to visit at some point. The user may provide the indication of the location, the proximity criteria, and the system then monitors the user's location on an ongoing basis to detect when the user, for other reasons, comes into proximity of that location. The user is then notified of the proximity and can even be given directions to go on to the vendor, if selected. This avoids the need to make a special trip to the vendor, saving time and expense.

In some embodiments, a plurality of users may be watching the same television program. In some households, a number of televisions may be available. Thus, many different users may wish to use the services described herein at the same time. To this end, the processor-based system 14 may maintain a table which identifies identifiers for the control devices 24, a television identifier and program information. This may allow users to move from room to room and still continue to receive the services described herein, with the processor-based system 14 simply adapting to different televisions, all of which receive their signal downstream of the processor-based 14, in such an embodiment.

In some embodiments, the table may be stored in the processor-based system 14 or may be uploaded to the head end 11 or, perhaps, even may be uploaded through the control device 24 to the cloud 28.

Thus, referring to FIG. 6, in some embodiments, a sequence 92 may be used to maintain a table to correlate control devices 24, television display screens 20, and channels being selected. Then a number of different users can use the system through the same television, or at least two or more televisions that are all connected through the same processor-based system 14, for example, in a home entertainment network. The sequence may be implemented as hardware, software, and/or firmware. In software and firmware embodiments, the sequence may be implemented using computer readable instructions stored on one or more non-transitory computer readable media, such as a magnetic, semiconductor, or optical storage. In one embodiment, the storage 50 may be used to store those instructions.

Initially, the system receives and stores an identifier for each of the control devices that provides commands to the system 14, as indicated in block 94. Then, the various televisions that are coupled through the system 14 may be identified and logged, as indicated in block 96. Finally, a table is setup that correlates control devices and television receivers (block 100). This allows multiple televisions to be used that are connected to the same control device in a seamless way so that viewers can move from room to room and continue to receive the services described herein. In addition, a number of viewers can view the same television and each can independently receive the services described herein.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
detecting occurrence of an event;
in response to detecting an event, automatically capturing an electronic decoded signal from a television program; and
performing a search using said signal to facilitate identification of a product depicted in the program.

2. The method of claim 1 including capturing a signal including an electronic representation of a video frame or clip, audio or metadata.

3. The method of claim 1 including automatically transferring said signal to a mobile device.

4. The method of claim 3 including providing search results to said mobile device.

5. The method of claim 3 including sending said signal to a remote server to perform said search.

6. The method of claim 1 including tracking a plurality of mobile devices, receiving requests from each of said devices, and providing responses to each device.

7. The method of claim 6 including maintaining a table correlating mobile devices and televisions and requests from mobile devices.

8. The method of claim 1 including automatically providing information about vendors of the product.

9. The method of claim 1 including enabling a user to use one mobile device to access two different televisions at different times.

10. At least one non-transitory computer readable medium storing instructions to enable a computer to:
detect the occurrence of an event;
in response to detection of an event, automatically capture an image; and
initiate a search using said image to facilitate identification of a product depicted in the image.

11. The medium of claim 10 further storing instructions to capture an electronic decoded signal in the form of an electronic representation of a video frame or clip, audio or metadata from a television program.

12. The medium of claim 10 further storing instructions to transfer said signal to a mobile device.

13. The medium of claim 12 further storing instructions to provide search results to said mobile device.

14. The medium of claim 12 further storing instructions to send said signal to a remote server to perform said search.

15. The medium of claim 10 further storing instructions to track a plurality of mobile devices, receive requests from each of said devices, and provide responses to each device to enable using two different televisions at different times.

16. The medium of claim 15 further storing instructions to maintain a table correlating devices, televisions, and requests for mobile devices.

17. The medium of claim 10 further storing instructions to capture a signal that is an electronic representation of an audio signal, convert said captured signal to text and send said text for use as an input for a keyword search.

18. The medium of claim 10 further storing instructions to provide information about vendors of the product.

19. An apparatus comprising:
a processor to automatically capture an electronic signal from a television program in response to said event, and transmit said decoded signal for use as an input for a keyword search to identify a product depicted in said signal; and
a storage coupled to said processor.

20. The apparatus of claim 10 wherein said apparatus is a mobile device.

21. The apparatus of claim 20 wherein said apparatus is a cellular telephone.

22. The apparatus of claim 20 wherein said apparatus is a remote control.

23. The apparatus of claim 19 wherein said apparatus is a television receiver.

24. The apparatus of claim 19 wherein said apparatus to signal a television receiving system to capture an electronic decoded signal in the form of an electronic representation of a video frame or clip, audio or metadata.

25. The apparatus of claim 20 wherein said apparatus to receive said signal from a television system and to transmit said signal to a remote device to perform a keyword search in a database or over the Internet.

26. At least one non-transitory computer readable medium storing instructions to enable a computer to:
receive a specified location;
monitor a user's current location; and
notify the user when the user is within a predetermined distance from said specified location.

27. The medium of claim 26 further storing instructions to search a captured electronic representation of a product and use an image search to identify said product.

28. The medium of claim 27 further storing instructions to search a captured electronic television signal to identify said product.

29. The medium of claim 28 further storing instructions to derive a product vendor location from Internet search results related to the product.

30. The medium of claim 26 further storing instructions to analyze audio from a television program to identify said program.
